(19) United States
(12) Patent Application Publication
(10) Pub. No.: US 2009/0064025 A1
(43) Pub. Date: Mar. 5, 2009

(54) KPI Builder

(76) Inventors: Thomas Christ, Kronau (DE); Karsten Priesett, Karlsruhe (DE); Andreas Storzum, Sandhausen (DE); Ulrike Janhoefer, Heidelberg (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/847,059

(22) Filed: Aug. 29, 2007

(51) Int. Cl. G06F 3/048

(52) U.S. Cl. 715/772

(57) ABSTRACT

A system and process that provides a set of tools and interfaces that facilitate the generation of reports for the monitoring of key performance indicators. The process may provide a basic set of measurement services that can be combined and re-used with one another to form more complex measurement services, queries and reports. The system provides an interface to facilitate the ease with which the basic measurement services can be modified and combined to create desired reports without the need for programming knowledge or skills.

### BACKGROUND

1. Field of the Invention

The invention relates to monitoring key performance indicators (KPIs). Specifically, the embodiments of the invention relate to a system and method for providing a set of tools for building KPI monitoring reports and displays of KPIs.

2. Background

Managers and employees at warehouses or other locations in a supply chain, frequently need to monitor different key performance indicators (KPIs) to determine how they and their facility are performing. Managers and employees each have different KPIs that are relevant to their work. Supply chain management (SCM) and electronic extended warehouse management (EWM) software track the relevant data, but extracting the data from these software suites, applications and platforms is difficult, especially for workers without the ability to program. These software suites, applications and platforms offer fixed reporting options. If a manger or employee needs a customized report then a programmer that is familiar with the database system and/or software suite, application or platform must be brought in to design and implement the customized report. This prohibits the creation of dynamic reports that are most pertinent to the manager or employee at a given time.

Reports that are packaged with a software suite, application or platform are designed for a specific purpose and not tailored to the needs of the manager or employee. They may not include each of the KPIs that the manager or employee desires to view or the correct relationship or function of the KPIs that are desired. If effort is put into the creation of a new report by a programmer that creates the desired report, then any modification of the report is likely to also require a programmer's assistance to implement. Further, the reports and effort that is put into creating the reports can not be easily re-used. This makes the created reports inflexible as they accumulate and take up space in the computer system thereby diminishing its performance. Executing the reports generates the requested analysis of KPIs, but the reports cannot be utilized for any other purpose.

### SUMMARY

Embodiments of the invention include a system and process that provides a set of tools and interfaces that facilitate the generation of reports for the monitoring of key performance indicators. The process may provide a basic set of measurement services that can be combined and re-used with one another to form more complex measurement services, queries and reports. The system provides an interface to facilitate the ease with which the basic measurement services can be modified and combined to create desired reports without the need for programming knowledge or skills.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a diagram of one embodiment of a key performance indicator builder system.

FIG. 2 is a flowchart of one embodiment of a process for the operation of the KPI builder.

FIG. 3A is a diagram of one embodiment of a basic measurement service editor interface.

FIG. 3B is a diagram of one embodiment of a basic measurement service group definition interface.

FIG. 4 is a diagram of one embodiment of a tailored measurement service.

FIG. 5 is a diagram of one embodiment of a tailored measurement service editor interface.

FIG. 6 is a flowchart of one embodiment of a process for defining a tailored measurement service.

FIG. 7 is a diagram of one embodiment of a calculated measurement service.

FIG. 8 is a diagram of one embodiment of a wizard for creating a calculated measurement service.

FIG. 9 is a diagram of one embodiment of a formula editor for a calculated measurement service.

FIG. 10 is a diagram of one embodiment of a process for defining a calculated measurement service.

FIG. 11A is a diagram of one embodiment of a display of underlying data by a warehouse monitor.

FIG. 11B is a diagram of one embodiment of a display of KPI data through a cockpit.

### DETAILED DESCRIPTION

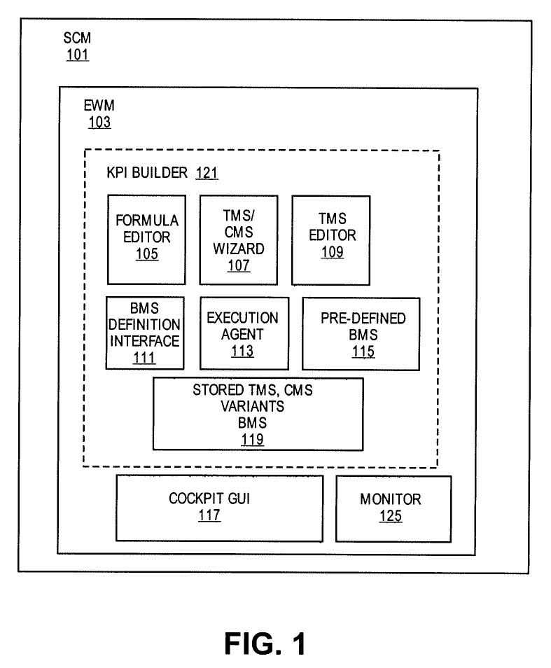

FIG. 1 is a diagram of one embodiment of a key performance indicator (KPI) builder system. The KPI builder system can be utilized in any system where measurable data is collected. Measurable data may be employee actions, equipment usage, product tracking and similar types of data. The data may be in object-oriented form. For example, the measurable data may be in the form of business object data. In one example embodiment, the KPI builder system is part of a supply chain management (SCM) system 101. The supply chain management system can be any SCM including SAP SCM by SAP AG of Walldorf, Germany or similar SCM systems. The SCM system 101 is an application or suite of applications that facilitate the management of products and items in a supply chain.

The SCM system 101 can include any number of applications or modules that relate to the management of a supply chain. These applications can include an extended warehouse manager (EWM) module 103. The EWM module 103 facilitates the management of products and items within a warehouse. The EWM module 103 can include any number of additional programs or databases that facilitate or support the management of warehouse data. The programs in the EWM module 103 can include a KPI builder 121 or a set of modules or components that provide the functionality for building KPI reports without the use of extensive programming skills.

The placement of the KPI builder 121 in an EWM module of a SCM system is one example environment for the implementation and use of the KPI builder 121. One skilled in the art would understand that the KPI builder 121 can be implemented or utilized in other enterprise resource management (ERP) systems and modules and in similar systems or as a separate or independent tool for defining reports based on queries of a set of databases or similar data stores.

The KPI builder 121 includes a number of functions that may be implemented as separate components, as a single integrated component or any combination thereof. The components of the KPI builder 121 include a formula editor 105, wizard 107, tailored measurement service (TMS) editor 109, a basic measurement service (BMS) editor 111, an execution agent 113, a set of pre-defined BMS's 115 and storage module 119.

The storage module 119 stores user defined and pre-defined BMS's, TMS's and calculated measuring services (CMS's) and related data such as variants. A BMS is a basic measurement service that queries or tracks a value in a data structure of the system. For example, the BMS can track, access or query data in business logic including business objects and similar data structures. The TMS and CMS are complex measurement services that are based on the basic building block of BMS's. The TMS refines at least one BMS with a variant. In one embodiment, the CMS applies a logical or mathematical operator to at least one TMS or other CMS. In another embodiment, the CMS can apply logical or mathematical operators to at least one BMS, CMS or TMS.

The storage module 119 may be accessible and shared amongst all of the KPI builder 121 modules. The storage module 119 can be a set of databases, file systems or similarly organized storage structures. A ‘set,’ as used herein, may refer to any positive whole number of items including one item. The database can be a relational database, object-oriented database or similar database. The storage module 119, as well as, the other components can be stored in a single storage device or distributed over a plurality of storage devices.

A BMS definition interface 111 may be a separate component, part of a single integrated KPI Builder 121 or a part of another component such as the user interface element of the KPI builder 121, EWM 103, SCM 101 or similar module or system. The BMS definition interface 111 provides a user interface and the functionality to a user to create, modify or delete a user defined or pre-defined BMS. A BMS is a simple measurement service. In other words, a BMS is a function module that runs a query. In another embodiment, the BMS may be a method (e.g., in an objected-oriented paradigm) or similar service capable of performing the query task or its equivalent. The BMS may also refine the results of the query. The BMS returns the results of the query and services as the basic building block of any report to monitor a KPI. The query may be a simple look up of a value in a database of the EWM 103, SCM 101 or similar module or system. In one embodiment, the BMS itself cannot be used alone. A variant must be defined to create a TMS to utilize the BMS. Thus the BMS is only a building block for a TMS. In another embodiment, the BMS may also be used alone or as a building block for a CMS.

A set of pre-defined BMS's can be provided by the KPI builder 121 provider. Any number of pre-defined BMS's can be provided. In one example, over 50 pre-defined BMS are provided. In one embodiment, the pre-defined BMS's can be stored as a separate component 115. The pre-defined BMS 115 may be a default or basic set of BMS's, while modified versions of the pre-defined BMS's are stored in the storage module 119. The values queried in the pre-defined BMS's are commonly utilized values. Thus, the pre-defined BMS's can service as the basic building block of more complex analysis of data without the use of without any typical programming effort or knowledge on the part of the user. The BMS's including user defined and pre-defined BMS's can be grouped into categories for ease of use.

A TMS editor 109 may be a separate component or a user interface element of an integrated KPI builder 121, EWM 103, SCM 101 or similar component. The TMS editor 109 provides a user interface that allows for the creation, modification or deletion of a TMS. A TMS is tailored measurement service that is built upon a single BMS and a variant. In another embodiment, the TMS may rely on multiple BMS's. The variant is a modification such as a filter or similar variation that performs a selection of output from a BMS to form a TMS. The variant may be a parameter of the BMS that determines the BMS output. The TMS is a self-contained service or component that returns a key figure or set of key figures based on the application of the variant to a BMS. In one embodiment, the TMS editor 109 may be a wizard that steps a user through the process of defining a TMS. In another embodiment, the TMS editor 109 is a graphical user interface (GUI) that presents a set of variants or allows a user to define a variant. The TMS editor GUI also presents a set of BMS's that are available. In one embodiment, a single BMS and variant are selected through the GUI to define a TMS. In another embodiment, a user selects a set of BMS's and variants and the relationship between the two sets to define a set of TMS's or a single TMS.

A TMS/CMS wizard 107 may be a separate component or a user interface element of the KPI builder 121, EWM 103, SCM 101 or similar module or system. The wizard 107 is a user interface that assists a user in creation, modification and deletion of a set of CMS's and/or TMS's. In one embodiment, a single wizard may perform both functions (i.e., defining both a TMS and a CMS). In another embodiment, separate CMS and TMS wizards are provided. The wizard 107 guides a user through the creation of a TMS and/or CMS. The creation of a TMS includes the selection of a BMS or set of BMS's upon which to build the TMS. The creation of a CMS includes the selection of a set of TMS upon which to build the CMS and the definition of a function to apply to the selected set of TMS's. A formula editor 105 can be included in the wizard 107 or be a separate component. The formula editor 105 provides a set of pre-defined functions (e.g. arithmetical operations like addition, subtraction, multiplication, division, exponentiation or similar operators) as well as an interface for the user to define new functions to apply to TMS's and form new CMS's.

An execution agent 113 is a component that executes a BMS, TMS or CMS. The execution agent 113 executes the queries, filters and functions the BMS's, TMS's and CMS's. The execution agent 113 may be a single module that updates each BMS, TMS or CMS over time or a separate instance of the execution agent 113 may update each BMS, TMS or CMS individually. The execution agent 113 can be configured by the user to determine the frequency at which each BMS, TMS and CMS is executed or updated and where the output of each BMS, TMS and CMS is sent. The execution agent 113 can write results to a file or similar data structure at regular intervals to create a log or history of results over time. In another embodiment, the execution agent 113 may be a part of another component of the system such as the EWM 103, SCM 101 or similar module or system.

A warehouse monitor or similar monitor 125 may be present in a related component such as the EWM 103 or SCM 101. The monitor 125 allows a user to view the underlying data in the system. This data may be navigated and displayed through a data hierarchy or by results generated by a BMS, TMS or CMS. Each of these data records may be displayed in a list format, table format or similar format that allows the user to more closely inspect the data that generated a KPI. The data may be selected to view additional more detailed information. The data may be sorted, accumulated or similarly organized through the monitor 125. The data can be organized to demonstrate the calculation of the associated KPI value.

A cockpit GUI 117 may be present in a related component such as the EWM 103 or SCM 101. The cockpit GUI 117 is a monitoring interface that allows a user such a warehouse manager or similar employee to see a graphical representation of selected warehouse conditions. The graphical representations can be bar graphs, current value printouts, charts, indexes and similar visual displays of information that can be easily understood by the user. A CMS, TMS or BMS can be selected for display through the cockpit GUI 117. Any number of CMS, TMS and BMS can be selected for viewing through the cockpit GUI 117. The CMS, TMS and BMS can be monitored over time and updated in real-time or may be similarly updated by an execution agent 113 or set of execution agents and the results can be passed to the cockpit GUI 117 to be displayed. The data displayed can be viewed in a list or similar format in a monitor 125. The monitor 125 and cockpit GUI 117 can provide links or similar user interface options to easily move between the two views of data.

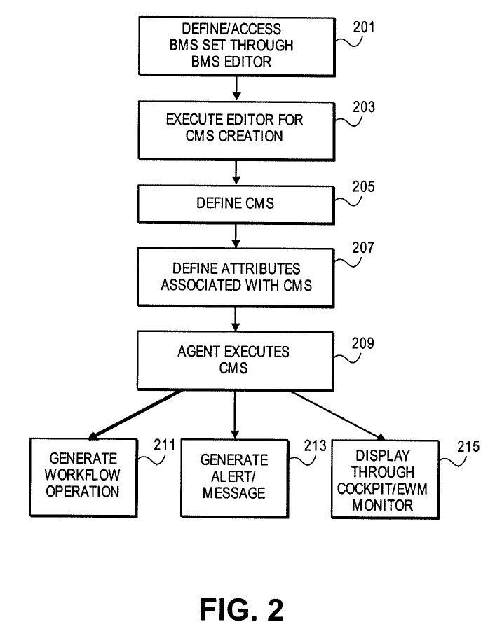

FIG. 2 is a flowchart of one embodiment of a process for operation of the KPI builder. The illustrated example is a process for creating and utilizing a CMS. One skilled in the art would understand that this example process is generally applicable to the creation and use of a BMS and TMS, which are simpler cases involving a subset of the steps involved in the creation and use of the CMS.

The process is started by accessing or defining a BMS or set of BMS's through the BMS definition interface (block 201). The process of defining a BMS may be undertaken by the provider of the KPI builder. A user can then utilize a pre-defined BMS or modify a pre-defined BMS. A user can also define a new BMS to query or monitor any value maintained by the associated systems such as the EWM system or SCM system. A user can define and store any number of BMS's.

The BMS editor can present a list or similar user interface mechanism of existing BMS's, including pre-defined BMS's and stored user-defined BMS's, for a user to select from. The BMS definition interface may be a GUI or similar interface to facilitate the use of the KPI builder system by individuals without programming knowledge or similar skill sets. The BMS definition interface can present the user with a list of possible values or data points from which to choose and a list of attributes that can be defined for the BMS. The selected data, which is the completed or defined BMS's, is stored into the storage module for re-use.

The interface for CMS/TMS generation is then initiated (block 203). This interface may be a single integrated interface or separate interfaces for the TMS and CMS management. The interface can be any combination of a wizard, formula editor, text editor or graphical editor or similar editing interface. The CMS/TMS services are defined through this interface and stored in the storage module for re-use. The user can select the BMS's that are to serve as building blocks and define the attributes of any needed TMS's as well as the final CMS's (block 207). The attributes may be defined by selecting the variants and formulas that are to be applied to the BMS's to create TMS's and CMS's.

Once a BMS, TMS or CMS is defined, then an execution agent can be assigned to it or it can be queried manually. The execution agent schedules the BMS, TMS or CMS for execution and executes it at the designated time. The user can configure the timing of the execution of each measurement service or type of measurement service as well as the components that receive the output of the measurement service. The execution agent can be configured to initiate a number of services in response to a trigger on the output of any type of measurement service. An execution agent can generate a workflow operation (block 211), generate an alert or message (block 213), display a result in a monitor or cockpit GUI (block 215) or can initiate similar actions (e.g. write to a data structure to create a log or history).

A workflow operation (block 211) can be any type of operation supported by the EWM, SCM or similar component that may be in communication with execution agent. The workflow operation can be generated in response to the detection of a defined condition as an output or error during the execution of a BMS, TMS or CMS. The workflow operations can be triggered based on any threshold values including exceeding thresholds, falling below thresholds or falling outside a defined threshold range (e.g., similar to a score-card). For example, a trigger linked to a BMS that monitors the level of inventory for a particular item may initiate the generation of a transfer or purchase order when the stock of a tracked item falls below a defined threshold level at the warehouse.

An alert message can be generated by the execution agent (block 213). The alert message can be any type of message or communication supported by the EWM, SCM or similar components or related systems. The execution agent generates the alert message in response to a monitored condition, set of thresholds or triggers based on the output of the BMS, TMS, or CMS. The alert message can be an email, a specialized signal that appears through a user interface, a text message or similar alert that is sent to any designated employee or user. For example, a warehouse manager may be sent a text message to alert him that an inventory level for a product has exceeded a threshold indicating a maximum storage capacity for that item.

The output of the various types of measurement services can be made available through the monitor or directly formatted for display through any user display interface, report or print out or similar output mechanism (e.g., a cockpit GUI) (block 215). For example, a screen or section of a monitor program or related program such as the cockpit GUI can receive the data output from the various types of measurement services. The cockpit GUI then formats the data according to selected display options and provides it to a user. These actions that are taken by an execution agent can be taken together in any combination, number or frequency.

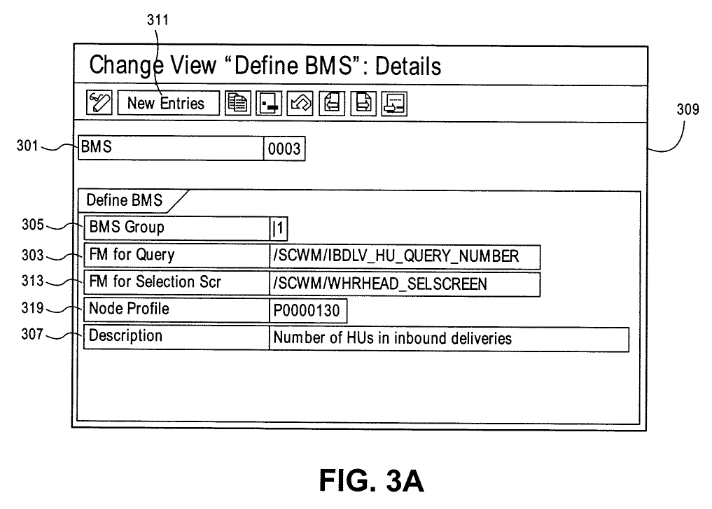

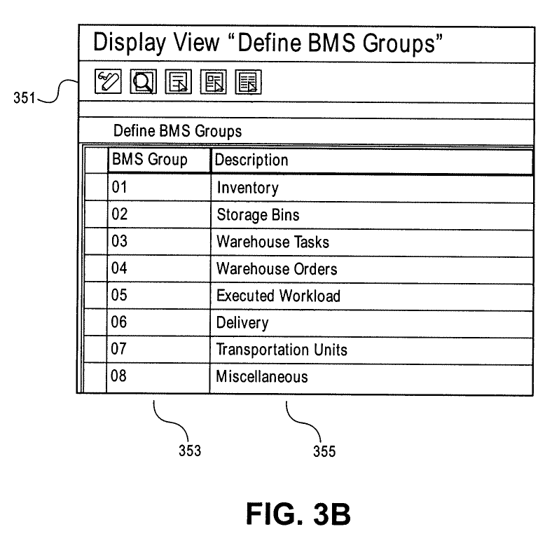

FIG. 3A is a diagram of one embodiment of a basic measurement service definition interface. The definition interface 309 is a graphical user interface for defining and modifying the attributes of a BMS. The definition interface 309 provides text fields, buttons, radio buttons, drop down menus and similar user interface mechanisms for selecting or inputting data to define the attributes of a BMS. The definition interface 309 provides a user interface mechanism to create a new entry 311. For example, a button is provided to generate a new BMS to be defined.

The definition interface 309 may display an identifier 301 for each BMS. The identifier can be user specified or automatically generated. The attributes of the BMS can include a BMS group 305, functional module (FM) for query 303, FM for selection screen 313, report ID 315, selection screen 317, node profile 319, description 307 and similar attributes. A BMS group 303 is a field that identifies a group that the BMS is associated with. The BMS can be grouped for ease of locating a BMS. A FM for query field 303 specifies or identifies the functional module (or in other embodiments a method or similar service) that is called when the BMS is executed. This refers to a service that is stored elsewhere in the system. The field may specify a path name, uniform resource locator or similar identifier. A FM for selection screen 313 identifies a functional module that provides the selection screen for the filters that can be used to define a TMS. A description field 307 is a text field in which a description of the BMS is stored. The node profile 319 specifies the related node in a monitor. The description field 307 can be of any size and provides a subsequent user with information about the functionality of the BMS to facilitate its re-use.

Any number of attributes can be associated with a BMS. The set of recorded attributes can be fixed or a user can define additional attributes. A completed BMS or partially completed BMS can be stored in the storage module. The BMS definition interface 309 can be utilized to modify, complete or delete any BMS in the storage module. The editor 309 can be accessible from the user interface of any component or system including the EWM, SCM and other components of the KPI builder.

FIG. 3B is a diagram of one embodiment of a basic measurement service group definition interface. The BMS definition interface can include a group definition interface 357. In another embodiment, the group definition interface 357 can be separate from the BMS definition interface. The group definition interface 357 can include a set of user interface mechanisms to create, modify or delete a BMS group. The group definition interface also displays a list of the existing BMS groups by an identifier 353 and a description 355. The identifier 353 can be any alphanumeric value. A description 355 can be in any format or size. Defining and using groups can assist a user in locating a BMS when a large number of BMS's have been defined, thereby allowing the user to re-use a BMS instead of having to redefine an existing BMS.

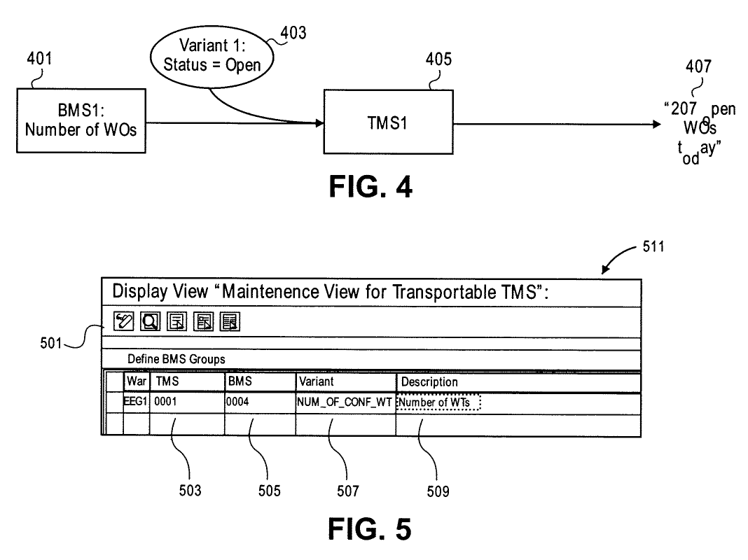

FIG. 4 is a diagram of one example embodiment of a tailored measurement service. This figure provides a graphical illustration of a TMS labeled TMS1 405. Such a graphical representation could be used for defining a TMS in a TMS editor where each available BMS, variant and TMS can be manipulated graphically and linked as blocks to define the TMS

In the example, BMS1 401 has been selected upon which TMS1 405 will be built. The BMS1 401 retrieves a number of warehouse orders (WO). A variant 403 is selected that modifies the results of the BMS1 401. The variant 403 in this example filters the warehouse orders and restricts the warehouse orders to the warehouse orders that have a status of open. The resulting TMS1 405 generates the number of warehouse orders that are open and that have been created “today” 407. In the example, the resulting value 407 is an integer that is returned by the TMS1 405 when executed by an execution agent or triggered manually.

FIG. 5 is a diagram of one embodiment of a tailored measurement service editor interface. The TMS editing interface 511 provides user interface mechanisms 501 to create, modify and delete TMS's. The TMS editing interface 511 can include a set of user defined attributes including a TMS identifier 503, BMS identifier 505, variant field 507, description field 509 or similar attributes. A TMS identifier 503 is an alphanumeric or similar value that is used to identify the TMS to facilitate its re-use. The BMS identifier 505 is a value that identifies a constituent BMS that is utilized to provide data that is further tailored by the TMS. The variant field 507 specifies the modification of the BMS data (i.e. the selection variant or filters). The variant can be any value or function or an identifier for a value or function. In one embodiment, a set of pre-defined variants are available for selection including variants defined by the KPI builder provider and by the user. The description field is a plain language description of the functionality of the TMS. The description field can be viewed by a subsequent user to obtain information to facilitate the re-use of the TMS.

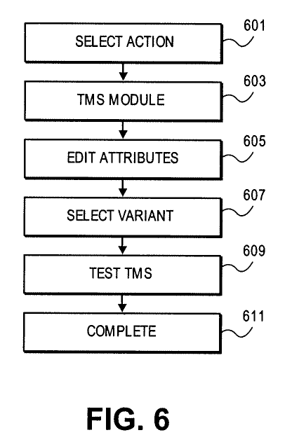

FIG. 6 is a flowchart of one embodiment of a process for defining a tailored measurement service. The process can be initiated by the selection of an action by a user (block 601). The selection of an action can be the selection of a user interface mechanism that initiates a TMS editor, a create option in a TMS editor or wizard or a similar action. In the case where a generalized wizard is employed (e.g., a wizard that handles both TMS and CMS management), a user further specifies that the action is to create, modify or delete a TMS module (block 603). The example of creation is described herein. One skilled in the art would understand that the principles described in relation to creation are generally applicable to the modification of a TMS module and that deletion can be easily executed upon identification and confirmation of the TMS module to be deleted.

The TMS editor or wizard presents the attributes to be edited or defined by the user (block 605). The attributes can be specified through a user interface mechanism such as a text field, menu or similar mechanism. Some mechanisms provide pre-defined options to the user, while others allow a user to define the attribute completely. One of the attributes that is specified is an input BMS or set of input BMS's. Each attribute can be presented in succession or any number can be presented at one time. A user also specifies a variant to apply to an input BMS or set of input BMS's (block 607). The variant can be chosen from a menu or list of available variants that is presented by the editor or wizard. In another embodiment, the variant is identified or similarly specified by the user.

A test function can be made available to a user to ensure that the TMS functions as intended (block 609). The test function can be part of the TMS editor or wizard. In another embodiment, the test function is a separate module or part of a debugging component of the KPI builder, EWM, SCM or similar component. If the user is satisfied with the test results, then the process completes (block 611). If the user is not satisfied with the test results, then the process can return to the definition of attributes or variants to allow a user to modify and correct the function of the TMS.

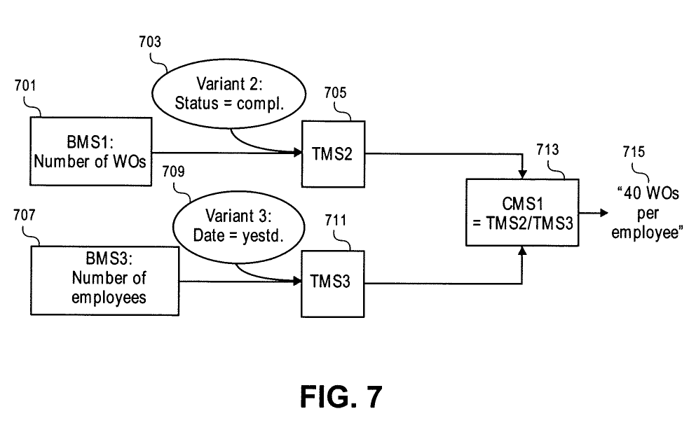

FIG. 7 is a diagram of one embodiment of a calculated measurement service. This figure provides a graphical illustration of a CMS labeled CMS1 713. Such a graphical representation could be used for defining a CMS in a CMS editor or wizard where each BMS, variant and TMS can be manipulated and linked as blocks to define the CMS.

In the example, a CMS1 713 is formed from two TMS's, TMS2 705 and TMS3 711. Each of the TMS's are composed of separate BMS's, BMS1 701 and BMS3 707, and separate variants 703, 709. CMS1 713 applies a function (in this case it divides TMS2 by TMS3) to TMS2 705 and TMS3 711 to generate a final value 715. In this example, BMS1 701 generates a number of warehouse orders (WOs). TMS2 705 filters the number of WOs produced by BMS1 701 to the completed WOs based on variant 703. BMS3 707 determines a number of employees. TMS3 filters the number of employees based on variant 709 to determine the number of employees that were working yesterday. The output of TMS2 705 (i.e, number of completed warehouse orders) is divided by the output of TMS3 711 (i.e., number of employees working yesterday) by CMS1 713 to produce a number of WOs completed per employee yesterday 715.

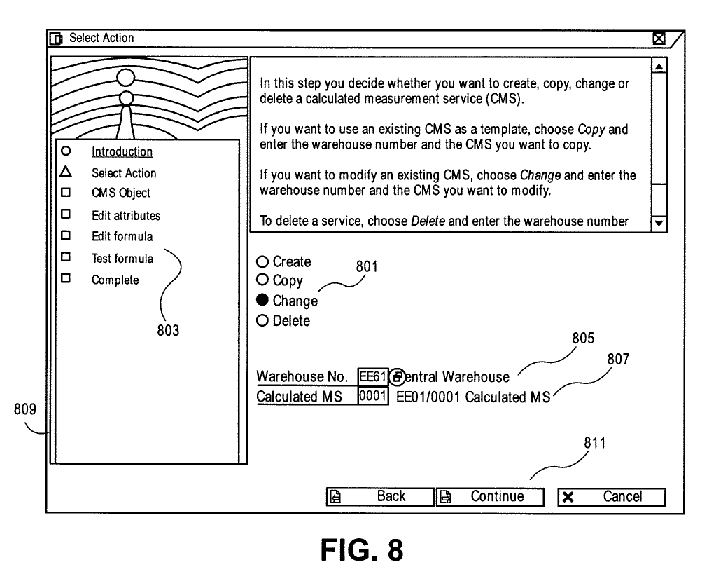

FIG. 8 is a diagram of one embodiment of a wizard for creating a calculated measurement service. In one embodiment, a CMS and/or TMS can be created through a wizard 809. The wizard 809 guides a user through a series of screens that prompt a user for input to accomplish a selected task. A task can be selected through selecting an action. A set of bookmarks 803 can be presented as navigation options to let a user skip ahead or go back in the wizard process. In the example wizard 809 screen illustrated, a user is given a set of options 801 to create, copy, change or delete a CMS. The user is also prompted to provide information related to the CMS to identify the CMS to be modified or created. The identifying information includes a warehouse number 805 associated with the CMS indicating the warehouse whose data is manipulated or evaluated by the CMS. The identifying information includes an identifier of the CMS such as an alphanumeric identifier 807. This identifier 807 may be a universally unique identifier or an identifier that is unique relative to the selected warehouse. The wizard 809 also presents a set of navigation buttons 811. These navigation items 811 could also be presented as other types of user interface mechanisms such as menu items or similar interface mechanisms. The navigation buttons 811 allow a user to confirm the input for the current wizard screen, to cancel the current input or similarly manage progress through the screens of the wizard.

One skilled in the art would understand that the wizard 809 can have any number of screens that guide a user through a process of creating, modifying or deleting a CMS. The options made available during the wizard process can be context specific that restrict options to those appropriate for defining a reusable CMS. For example, only a subset of BMS's may be indicated as available for defining inventory related tracking. In defining a TMS, only those variants that further refine a BMS may be offered. Similarly, the principles and techniques described in relation with management of CMS's are also applicable to the management of TMS's through a wizard. The screens of a wizard can collect and store any number of data items, attributes or similar information about the CMS or TMS. For example, the categories of screens that are presented to a user for a wizard can include an introduction screen, an action selection screen, an edit attribute screen, an edit formula screen, a test formula screen and a completion screen.

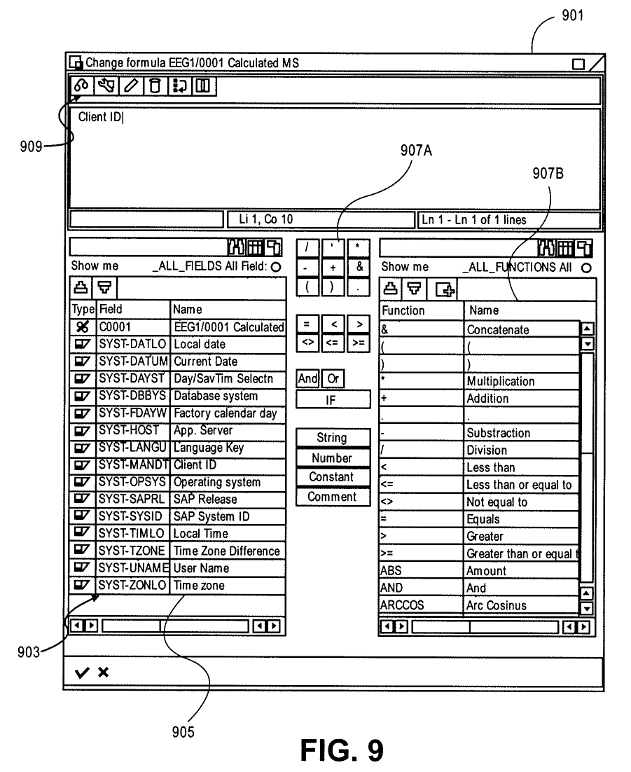

FIG. 9 is a diagram of one embodiment of a formula editor for a calculated measurement service. A formula editor 901 can be a part of a wizard for CMS creation or a separate component that interacts with the wizard. The formula editor provides an interface element to display a set of TMS or BMS 903 that a user can select to operate upon when defining the operation of the CMS or its constituent inputs. The display of available TMS and/or BMS 903 can include a correlated list of descriptions 905 of the TMS and/or BMS. The user can select the necessary TMS and BMS inputs for a desired output of the CMS. In one embodiment, the interface element 903 not only contains the set of available BMS and TMS but also a variety of available data values. For example, data values may include “current data SY-DATLO”, “local time-zone SY-ZONLO” that can be used in the creation of a CMS (like the “yesterday” function in the example above).

The editor 901 includes a set of quick links 907A to functions that are commonly used and can be selected to apply to the selected TMS or BMS modules. A more complete list 907B with descriptions of each function can also be provided for the user to select from. The user can design a function of any level of complexity using the available TMS's and/or BMS's as building blocks and the available functions including user defined functions to manipulate the output of selected TMS's and/or CMS's. A function to be applied to a set of BMS's and TMS's can include any logical operator such as a Boolean operator, arithmetic operators and similar operators and functions. A user defined formula is stored in the storage module as well as any user defined CMS's. Subsequent users can access and re-use any portion of these formulas and CMS's through the TMS/CMS wizard, the formula editor 901 or similar interface.

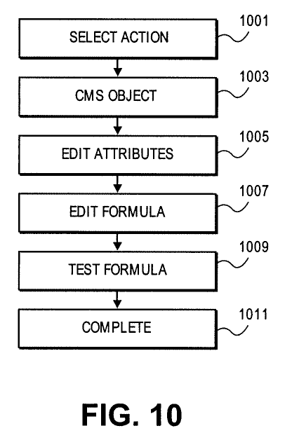

FIG. 10 is a diagram of one embodiment of a process for defining a calculated measurement service. The process can be initiated by the selection of an action by a user (block 1001). The selection of an action can be the selection of a user interface mechanism that initiates a CMS editor, a create option in a CMS editor or wizard or a similar action. In the case where a generalized wizard is employed (e.g., a wizard that handles both TMS and CMS management), a user further specifies that the action is to create, modify or delete a CMS module (block 1003). The example of creation is described herein. One skilled in the art would understand that the principles described in relation to creation are generally applicable to the modification of a CMS module and that deletion can be easily executed upon identification and confirmation of the CMS module to be deleted.

The CMS editor or wizard presents the attributes to be edited or defined by the user (block 1005). The attributes can be specified through a user interface mechanism such as a text field, menu or similar mechanism. Some mechanisms provide pre-defined options to the user, while others allow a user to define the attributes completely. One of the attributes that is specified is an input BMS or TMS or set of input BMS's and/or TMSs's. Each attribute can be presented in succession or any number can be presented at one time through separate screens of an editor or wizard. A user also specifies a function or set of functions to apply to an input BMS or TMS or set of input BMSs's and/or TMSs's (block 1007). The set of formulas can be chosen from a menu or list of available formulas that is presented by the formula editor or CMS wizard. In another embodiment, the formula is identified or similarly specified by the user. For example, a user can input a mathematical formula through a text editor or field or similar input mechanism that is applied to the output of the selected set of BMSs's and/or TMSs's.

A test function can be made available to a user to ensure that the CMS functions as intended (block 1009). The test function can be part of the CMS editor or wizard. In another embodiment, the test function is a separate module or part of a debugging component of the KPI builder, EWM, SCM or similar component. If the user is satisfied with the test results, then the wizard completes (block 1011). If the user is not satisfied with the test results, then the wizard can return to the screens related to the definition of attributes or formulas to allow a user to modify and correct the functions of the CMS.

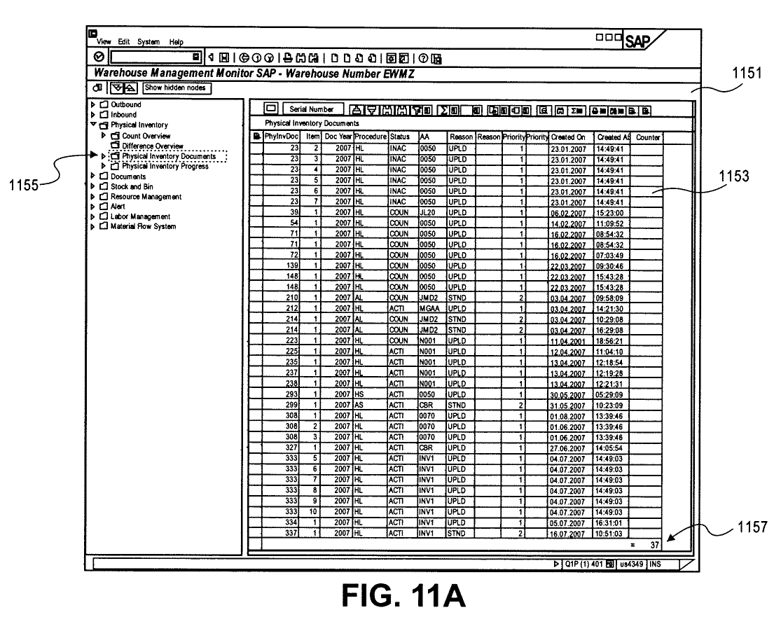

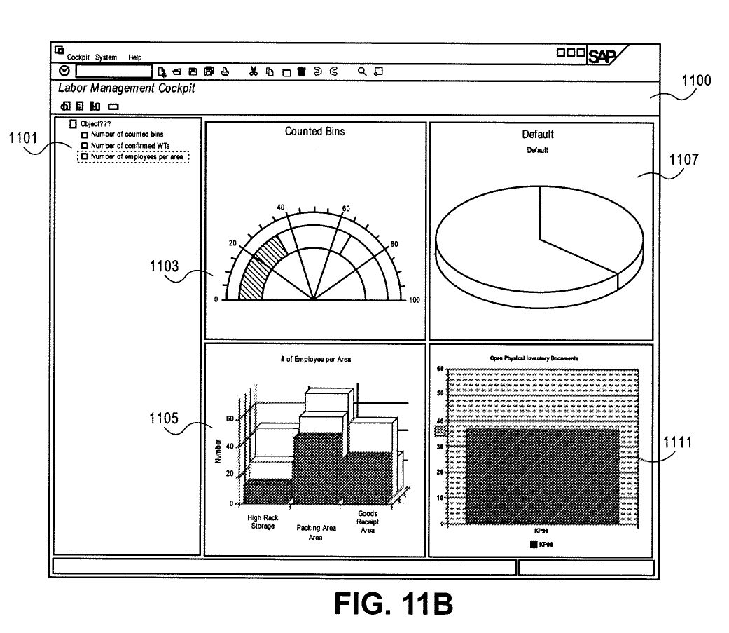

FIG. 11A is a diagram of one embodiment of a display of underlying data by a warehouse monitor 1151. The warehouse monitor 1151 presents data in a table, list or similar flat format. Any number of data items and values can be displayed at a given time. The data that is displayed may be based on the navigation of a data hierarchy, results from a BMS, TMS or CMS or similar data. A data hierarchy can be navigated through a navigation tree 1155 or similar navigation interface. The data at each level of the tree (i.e., each node in the tree) or the results of a BMS, TMS or CMS (e.g. business objects) can be displayed as a set of documents 1152, records or similar groupings of data.

The monitor 1151 is a user interface that can provide utilities or interface mechanisms to allow for the sorting, filtering, ranking or similar organization of the data. Any variant can be applied to the data and a list of variants can be provided. The monitor can also display a calculation of KPI data based on the data. In the illustrated example, the number of physical inventory documents 1157 that are open are tallied. This KPI indicator can be viewed through other mechanisms such as a cockpit GUI or similar interface.

FIG. 11B is a diagram of one embodiment of a display of KPI data through a cockpit. A cockpit 1100 is a GUI that serves as an example output and display of the data collected or calculated by the KPI builder through the execution of BMS's, TMS's and CMS's by their respective execution agents. One skilled in the art would understand that the output of data through a cockpit is one example of the output of the data and that the principles and techniques described also apply to other embodiments of output including reports, electronic mail, audio and video output and similar output devices and destinations.

The BMS, TMS or CMS available for display may be presented in a menu 1101 table or similar presentation. Any number of measurement services can be selected for display at one time. Each selected measurement service can be displayed in a separate format. For example, the collected data can be displayed in the form of a meter 1103, pie chart 1107, bar graph 1105, or similar form for displaying collected data. The individual displays of data can be manipulated to occupy different portions and proportions of the cockpit display. The display of data through the cockpit 1100 may be updated continuously, intermittently or at the direction of a user.

The data displayed through the cockpit 1100 can also be used to access the underlying data through other interface mechanisms. For example, the chart of open physical inventory documents 1111 can be used to access the corresponding data in a monitor such as that illustrated in FIG. 11A. The data can be selected through any user input and the monitor automatically launched or brought into focus with the corresponding data.

The wizards, editors and similar user interfaces and components of the KPI builder may also provide additional functionality including export and import capability. BMS's, TMS's, CMS's, variants, formulas and other data stored in the storage module can be exported to other compatible SCM, EWM or similar systems. Similarly, other user defined BMS's, TMS's, CMS's, variants formulas and other related data can be imported from similar SCM, EWM and other systems.

In one embodiment, the KPI builder and its constituent components may be implemented as hardware devices. In another embodiment, these components may be implemented in software (e.g., microcode, assembly language or higher level languages). These software implementations may be stored on a machine-readable medium. A “machine readable” medium may include any medium that can store or transfer information. Examples of a machine readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
defining a set of basic measurement services to query business object values;
displaying an interface to permit combination of a subset of the basic measurement services to form a complex service; and
executing the complex service to generate a key performance indicator.

2. The method of claim 1, further comprising:
displaying the key performance indicator through a graphical user interface.

3. The method of claim 1, further comprising:
initiating a workflow process in response to key performance indicator generation.

4. The method of claim 3, further comprising:
comparing the key performance indicator to a threshold value; and
generating an alert in response to the key performance indicator exceeding the threshold value.

5. The method of claim 1, wherein executing the complex service comprises:
filtering the input of the at least one basic measurement service.

6. The method of claim 1, wherein executing the complex service comprises:
applying an arithmetic or boolean operator to another complex service.

7. The method of claim 1, further comprising:
generating a wizard screen to guide creation of the complex service.

8. The method of claim 1, further comprising:
generating a formula creator interface to function to apply in the complex service.

9. The method of claim 1, further comprising:
reusing the complex service.

10. The method of claim 1, further comprising:
exporting the complex services to a compatible program.

11. An apparatus comprising:
a plurality of predefined basic measurement services that retrieve business object data; and
a user interface module to facilitate user manipulation of a basic measurement service to define a complex measurement service that modifies an output of the basic measurement service to generate a key performance indicator.

12. The apparatus of claim 11, further comprising:
a display module to display the key performance indicator as a graphical element.

13. The apparatus of claim 11, further comprising:
an agent to execute the complex measurement service and monitor for the key performance indicator to exceed a threshold value and initiate a function in response.

14. The apparatus of claim 13, wherein the function is an alert or email.

15. The apparatus of claim 11, wherein the user interface comprises:
a wizard that presents a context appropriate subset of the predefined basic measurement services and modification options to define a reusable service.

16. The apparatus of claim 11, wherein the user interface comprises:
an editor that presents algorithms or logic to be applied to a listing of predefined basic measurement services that are selectable by a user.

17. A machine readable medium having instructions stored therein, which when executed cause a machine to perform a set of operations comprising:
defining a set of predefined queries of business object data;
generating a user interface providing a list of the predefined queries and options to filter the queries or perform a function on the queries;
defining a complex operation based on user selections of the options; and
executing the complex operation to generate a key performance indicator.

18. The machine readable medium of claim 17, having further instructions stored therein, which when executed cause a machine to perform a set of operations further comprising:
displaying the key performance indicator through a graphical user interface as a graph, chart or index.

19. The machine readable medium of claim 17, having further instructions stored therein, which when executed cause a machine to perform a set of operations further comprising:
monitoring the key performance indicator to determine whether it is within a set of threshold values; and
triggering an action upon detecting the KPI is outside the set of threshold values.

20. The machine readable medium of claim 17, wherein the instructions causing the machine to perform the operation of generating the user interface causes the machine to:
presenting the predefined queries and options as graphical elements.

21. The machine readable medium of claim 17, further comprising:
displaying business object data supporting the key performance indicator based on the complex operation through a monitor interface.
